(19) United States
(12) Patent Application Publication
(10) Pub. No.: US 2016/0130172 A1
(43) Pub. Date: May 12, 2016

(54) METHOD FOR SCRIBING TEMPERED GLASS PLATE AND METHOD FOR CUTTING TEMPERED GLASS PLATE

(71) Applicant: NIPPON ELECTRIC GLASS CO., LTD., Shiga (JP)

(72) Inventors: Hiroyuki NAKATSU, Shiga (JP); Hisahiro TAKEUCHI, Shiga (JP); Kiyotaka KINOSHITA, Shiga (JP); Hayato OKU, Shiga (JP)

(21) Appl. No.: 14/897,001

(22) PCT Filed: Jun. 26, 2014
(86) PCT No.: PCT/JP2014/067028

§ 371 Date: Dec. 9, 2015

(30) Foreign Application Priority Data
Jun. 27, 2013 (JP) 2013-135016

(51) Int. Cl. C03B 33/10; B26F 3/00; C03B 33/03

(52) U.S. Cl. CPC C03B 33/107; C03B 33/03; B26F 3/002

(57) ABSTRACT

Provided is a method of scribing a tempered glass sheet, which involves forming a scribe line (S) for cutting a tempered glass sheet (G) with a scribing wheel (H) moving along a preset cutting line (CL) while pressing a front surface (Ga) of the tempered glass sheet (G), the method including: starting the forming of the scribe line (S) by causing the scribing wheel (H) to climb onto an edge portion (Ea), which is one of edge portions of the tempered glass sheet (G) positioned on one end side of the preset cutting line (CL); and finishing the forming of the scribe line (S) by moving the scribing wheel (H) to a position where a vicinity of an edge portion (Eb), which is another of the edge portions of the tempered glass sheet (G) positioned on another end side of the preset cutting line (CL), remains as an unscribed portion.

### TECHNICAL FIELD

The present invention relates to a method of scribing a tempered glass sheet, which involves forming a scribe line for cutting the tempered glass sheet by moving a rotary scribing blade, and also to a method of cutting a tempered glass sheet.

### BACKGROUND ART

As is well known, tempered glass sheets are obtained by tempering their surface layer regions through ion exchange or air cooling tempering so that compressive stress layers are formed on a front surface side and a back surface side of each of the tempered glass sheets in their thickness direction and a tensile stress layer is formed between the compressive stress layers on both sides. As compared to normal glass sheets, the fracture strength of the tempered glass sheets against tensile stress to be applied to each of the surface layer regions is enhanced significantly.

To cut the tempered glass sheet, for example, the following method has widely been employed. That is, a scribing wheel is moved to press the front surface of the tempered glass sheet along a preset cutting line, to thereby form a scribe line (see Patent Literature 1). The scribe line includes a median crack extending in the thickness direction. After that, bending moment is applied onto the periphery of the scribe line to execute snapping, to thereby cut (cleave) the tempered glass sheet.

### CITATION LIST

Patent Literature 1: WO 2012/009253

### SUMMARY OF INVENTION

### Technical Problem

Incidentally, when the scribe line is formed in the tempered glass sheet by the method disclosed in Patent Literature 1, the following problems arise in cutting the tempered glass sheet by snapping.

That is, the formation of the scribe line disclosed in Patent Literature 1 is initiated through the movement of the scribing wheel started at a position spaced inwardly away from an edge portion of the tempered glass sheet. Due to this operation, in an initial stage of forming the scribe line, the scribing wheel may idly roll without suitably rolling on the front surface of the tempered glass sheet. Thus, there is such a drawback that the scribe line (median crack) is liable to be formed to have a depth smaller than a depth suited to the execution of snapping.

Therefore, the tempered glass sheet is snapped along the scribe line formed shallower in the vicinity of the starting end of the scribe line, and hence excessive bending moment needs to be applied to the tempered glass sheet as compared to the case where the snapping is executed along the scribe line formed to have an appropriate depth. As a result, when the snapping is executed, the crack generated from the scribe line (median crack) propagates in an unintended direction as in a situation where the crack deviates from a direction perpendicular to the front surface of the tempered glass sheet, thereby causing trouble of significant degradation in quality of cut surfaces formed in the tempered glass sheet.

The present invention has been made in view of the above-mentioned circumstances, and it is therefore a technical object of the present invention to avoid degradation in quality of cut surfaces of a tempered glass sheet when the tempered glass sheet is cut by snapping.

### Solution to Problem

The present invention, which is devised to achieve the above-mentioned object, has a feature in a method of scribing a tempered glass sheet, which involves forming a scribe line for cutting the tempered glass sheet with a rotary scribing blade moving along a preset cutting line while pressing a front surface of the tempered glass sheet, the method comprising: starting the forming of the scribe line by causing the rotary scribing blade to climb onto one of edge portions of the tempered glass sheet, which is positioned on one end side of the preset cutting line; and finishing the forming of the scribe line by moving the rotary scribing blade to a position where a vicinity of another of the edge portions of the tempered glass sheet, which is positioned on another end side of the preset cutting line, remains as an unscribed portion.

The description “climb onto one of edge portions” herein refers to an operation of the rotary scribing blade moving upward to reach the front surface of the tempered glass sheet when the rotary scribing blade forms the scribe line at the edge portion. Further, the description “another of the edge portions of the tempered glass sheet, which is positioned on another end side of the preset cutting line,” encompasses not only the edge portion forming an outer peripheral profile of the tempered glass sheet but also a minute edge portion formed by the front surface of the tempered glass sheet and another scribe line already formed in the tempered glass sheet.

With this method, the rotary scribing blade is hooked onto the edge portion positioned on one end side of the preset cutting line when climbing onto the edge portion, thereby preventing idle rolling of the rotary scribing blade to start the rolling suitably. Therefore, even in an initial stage of forming the scribe line, the depth of the scribe line can be set to a depth suited to the operation of cutting the tempered glass sheet by snapping. Thus, when the tempered glass sheet is cut by snapping along the scribe line, there is no need to apply excessive bending moment to the tempered glass sheet, thereby being capable of preventing such a situation that a crack generated from the scribe line propagates in an unintended direction as in a situation where the crack deviates from a direction perpendicular to the front surface of the tempered glass sheet. As a result, it is possible to avoid degradation in quality of cut surfaces formed in the tempered glass sheet. Further, the formation of the scribe line is finished under a state in which the rotary scribing blade is moved to the position where the vicinity of the edge portion positioned on the other end side of the preset cutting line remains as an unscribed portion, thereby being capable of appropriately avoiding the following trouble. That is, when the scribe line is formed to reach the edge portion positioned on the other end side, and when the tempered glass sheet is conveyed by, for example, a belt conveyor, the crack generated from the scribe line may propagate in a thickness direction due to a tensile stress layer formed in the tempered glass sheet so that the tempered glass sheet is cut over the entire length of the scribe line during the conveyance of the tempered glass sheet. That is, the tempered glass sheet is cut at an unintended timing. As a result, the opposing cut surfaces are brought into contact with each other due to vibrations or the like during the conveyance, thereby causing such a situation that the quality of the cut surfaces is degraded. According to the one embodiment of the present invention, however, the tempered glass sheet is prevented from being cut at the unscribed portion, thereby being capable of suitably eliminating the risk of such a situation.

In the above-mentioned method of scribing a tempered glass sheet, it is preferred that a depth of the scribe line be set to 3 times or more of a thickness of a compressive stress layer formed in a surface layer region of the tempered glass sheet, and to 60% or less of a thickness of the tempered glass sheet.

With this setting, the scribe line is formed deeper in the thickness direction than in the related art. Thus, when the tempered glass sheet is cut by snapping along the scribe line, the tempered glass sheet can be snapped with small bending moment, and the propagation of the crack generated from the scribe line in an unintended direction is prevented more appropriately. Further, the permissible range of the depth of the scribe line to be formed is wider than in the related art. Therefore, when forming the scribe line, the scribe line can stably be formed to have a depth within the above-mentioned range even though the pressing force of the rotary scribing blade for pressing the tempered glass sheet is fluctuated by, for example, small unevenness on the front surface of the tempered glass sheet. That is, the control of the pressing force can be facilitated significantly.

In the above-mentioned method of scribing a tempered glass sheet, it is preferred that the starting of the forming of the scribe line comprise causing the rotary scribing blade to climb onto the one of the edge portions, which is positioned on the one end side of the preset cutting line, in a direction orthogonal to the one of the edge portions.

With this method, the rotary scribing blade is hooked onto the edge portion more easily, which leads to a further advantage in forming the scribe line having a depth suited to the operation of cutting the tempered glass sheet in the initial stage of forming the scribe line.

In the above-mentioned method of scribing a tempered glass sheet, it is preferred that a separation distance between the another of the edge portions, which is positioned on the another end side of the preset cutting line, and a terminal end of the scribe line be set to 0.5 times or more and 3 times or less of a diameter of the rotary scribing blade.

When the separation distance between the terminal end of the scribe line and the edge portion positioned on the other end side of the preset cutting line is excessively short, after the formation of the scribe line is finished, the crack generated from the scribe line may propagate due to the tensile stress layer formed in the tempered glass sheet to reach the edge portion positioned on the other end side of the preset cutting line. At this time, the tempered glass sheet is in a state in which the scribe line connecting the edge portion positioned on one end side of the preset cutting line and the edge portion positioned on the other end side of the preset cutting line is formed in the tempered glass sheet. Therefore, the following trouble may occur in, for example, a production line of cutting the tempered glass sheet by snapping after the scribe line is formed in the tempered glass sheet at a step on an upstream side and the tempered glass sheet is conveyed to a step on a downstream side by a belt conveyor or the like. That is, the crack generated from the scribe line may propagate in the thickness direction due to the tensile stress layer formed in the tempered glass sheet so that the tempered glass sheet is cut over the entire length of the scribe line during the conveyance of the tempered glass sheet. That is, the tempered glass sheet is cut at an unintended timing. As a result, the opposing cut surfaces are brought into contact with each other due to vibrations or the like during the conveyance, thereby causing such a situation that the quality of the cut surfaces is degraded. On the other hand, when the separation distance is excessively long, and when the tempered glass sheet is cut by snapping along the scribe line, the crack generated from the scribe line may propagate in an unintended direction deviating from the preset cutting line. When the separation distance falls within the above-mentioned range, however, this trouble can be avoided suitably.

In the above-mentioned method of scribing a tempered glass sheet, it is preferred that a cutting edge of the rotary scribing blade have a plurality of cutout portions formed therein along a circumferential direction of the rotary scribing blade, that a formation pitch of the plurality of cutout portions range from 20 μm to 160 μm, that a depth of each of the plurality of cutout portions range from 1.0 μm to 2.5 μm, and that a width of the each of the plurality of cutout portions along the circumferential direction of the rotary scribing blade range from 3 μm to 8 μm.

When the formation pitch of the cutout portions is smaller than 20 μm or larger than 160 μm, the rotary scribing blade is difficult to roll appropriately due to a slip of the rotary scribing blade on the front surface of the tempered glass sheet or the like, thereby causing a risk of difficulty in forming the scribe line. Further, when the depth of each of the cutout portions is smaller than 1.0 μm, there is a risk of difficulty in forming the scribe line having a sufficient depth to cut the tempered glass sheet. On the other hand, when the depth of each of the cutout portions is larger than 2.5 μm, the impact force applied to the tempered glass sheet becomes excessively large during the formation of the scribe line, thereby causing a risk in that self-breakage of the tempered glass sheet may be induced by the tensile stress applied inside the tempered glass sheet. Further, when the width of each of the cutout portions along the circumferential direction of the rotary scribing blade is smaller than 3 μm, there is a risk of difficulty in forming the scribe line having a sufficient depth to cut the tempered glass sheet. On the other hand, when the width is larger than 8 μm, the front surface of the tempered glass sheet is liable to shatter during the formation of the scribe line so that glass powder is generated, thereby causing a risk in that the product value of the tempered glass sheet may be degraded or the strength of the cut surfaces may be decreased. When the formation pitch, depth, and width of the cutout portions are set within the above-mentioned ranges, however, the risk of the above-mentioned trouble can be eliminated to the extent possible.

In the above-mentioned method of scribing a tempered glass sheet, it is preferred that the tempered glass sheet comprise: compressive stress layers formed in surface layer regions on a front surface side and a back surface side of the tempered glass sheet, respectively; and a tensile stress layer formed between both the compressive stress layers, and that the following relationships be satisfied:

300≦t≦2,000;

−0.00308×t+20.5343≦CT≦−0.00405×t+27.3791; and

600≦CS≦700,

where a thickness of the tempered glass sheet is represented by t [μm], a magnitude of compressive stress applied to each of the compressive stress layers is represented by CS [MPa], and a magnitude of tensile stress applied to the tensile stress layer is represented by CT [MPa].

The scribe line can be formed particularly suitably in such a tempered glass sheet that the thickness t of the tempered glass sheet, the magnitude CS of the compressive stress applied to each of the compressive stress layers, and the magnitude CT of the tensile stress applied to the tensile stress layer satisfy the above-mentioned relationships.

In the above-mentioned method of scribing a tempered glass sheet, it is preferred that the starting of the forming of the scribe line comprise bringing the rotary scribing blade into contact with the one of the edge portions, which is positioned on the one end side of the preset cutting line, under an accelerated state.

With this method, the rotary scribing blade is brought into contact with the edge portion under the accelerated state, thereby being capable of easily causing the rotary scribing blade to climb onto the edge.

Further, the present invention has a feature in a method of cutting a tempered glass sheet, comprising: cutting the tempered glass sheet into a strip shape by using the above-mentioned method of scribing a tempered glass sheet; and further cutting the tempered glass sheet having the strip shape into individual segments.

When the tempered glass is cut into individual segments after the tempered glass is cut into a strip shape as described above, cutting failure such as a split in an unintended direction and self-breakage due to the compressive stress and the tensile stress can be suppressed as compared to, for example, a case where the tempered glass is snapped after the scribe lines are formed in a plurality of directions.

In addition, the present invention has a feature in a method of cutting a tempered glass sheet, comprising: forming a scribe line in the tempered glass sheet by using the above-mentioned method of scribing a tempered glass sheet; and cutting the tempered glass sheet by snapping through application of bending stress to the tempered glass sheet.

In the above-mentioned method of scribing a tempered glass sheet, it is preferred that the cutting of the tempered glass sheet by snapping comprise applying the bending stress to the tempered glass sheet within 180 seconds after the forming of the scribe line in the tempered glass sheet.

When the tempered glass sheet is cut through the application of bending stress after the scribe line is formed as described above, the tempered glass sheet can securely be cut without natural propagation of the crack of the scribe line.

### Advantageous Effects of Invention

As described above, according to the present invention, it is possible to avoid the degradation in quality of the cut surfaces of the tempered glass sheet when the tempered glass sheet is cut by snapping.

### BRIEF DESCRIPTION OF DRAWINGS

FIG. 1a is a side view of a scribing wheel to be used for a method of scribing a tempered glass sheet according to each of embodiments of the present invention.

FIG. 1b is a front view of the scribing wheel to be used for the method of scribing a tempered glass sheet according to each of the embodiments of the present invention.

FIG. 2 is a plan view of a method of scribing a tempered glass sheet according to a first embodiment of the present invention.

FIG. 3 is a side view of the method of scribing a tempered glass sheet according to the first embodiment of the present invention.

FIG. 4 is a side view of the method of scribing a tempered glass sheet according to the first embodiment of the present invention.

FIG. 5 is a plan view of a method of scribing a tempered glass sheet according to a second embodiment of the present invention.

FIG. 6 is a side view of the method of scribing a tempered glass sheet according to the second embodiment of the present invention.

FIG. 7 is a plan view of a method of scribing a tempered glass sheet according to a third embodiment of the present invention.

FIG. 8 is an enlarged view of the portion Z of FIG. 7.

FIG. 9 is a side view of the method of scribing a tempered glass sheet according to the third embodiment of the present invention.

FIG. 10 is a conceptual graph of scribing velocity control according to each of the embodiments of the present invention.

### DESCRIPTION OF EMBODIMENTS

Now, embodiments of the present invention are described with reference to the accompanying drawings. Note that, in a method of scribing a tempered glass sheet according to each of the embodiments to be described below, the tempered glass sheet for which the method is carried out is only one structural example, and as described later, the method of scribing a tempered glass sheet according to the present invention is not intended for the tempered glass sheet alone.

First, description is given of the structure of a scribing wheel serving as a rotary scribing blade to be used for the method of scribing a tempered glass sheet according to each of the embodiments of the present invention.

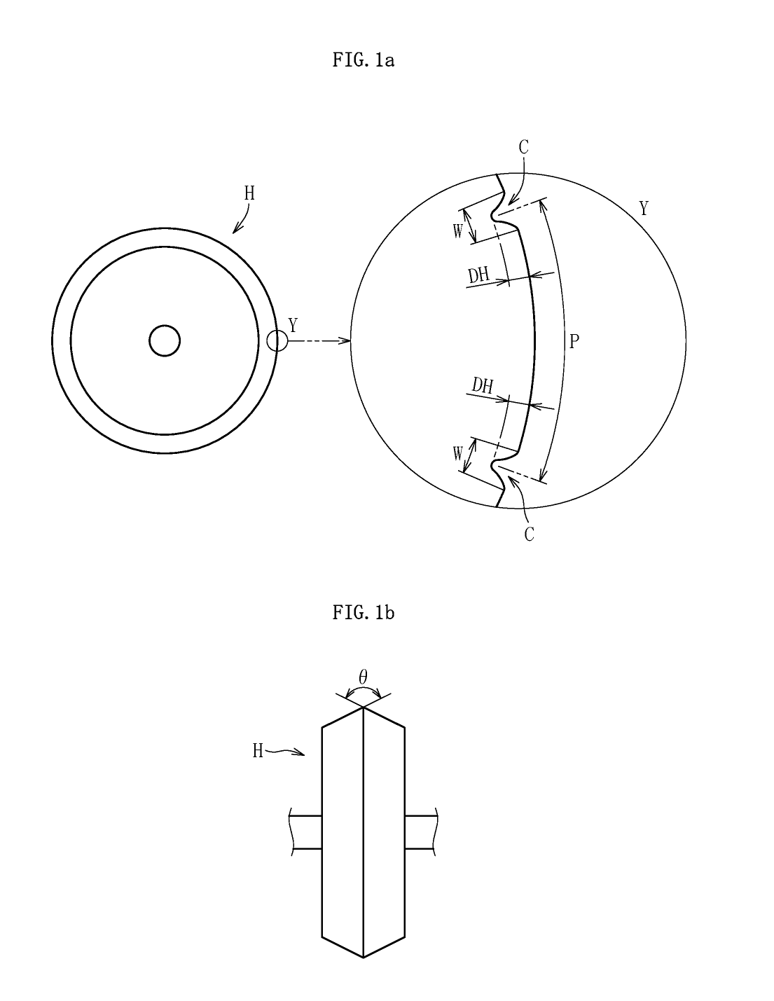

As illustrated in FIG. 1a, a plurality of cutout portions C are formed in a cutting edge of a scribing wheel H along its circumferential direction. Further, a formation pitch P of the plurality of cutout portions C is set to from 20 μm to 160 μm. Still further, a depth DH of each of the plurality of cutout portions C is set to from 1.0 μm to 2.5 μm, and a width W of each of the plurality of cutout portions C along the circumferential direction is set to from 3 μm to 8 μm. Besides, an opening angle θ of the cutting edge of the scribing wheel H illustrated in FIG. 1b is set to from 110° to 150°.

Now, a method of scribing a tempered glass sheet according to a first embodiment of the present invention is described.

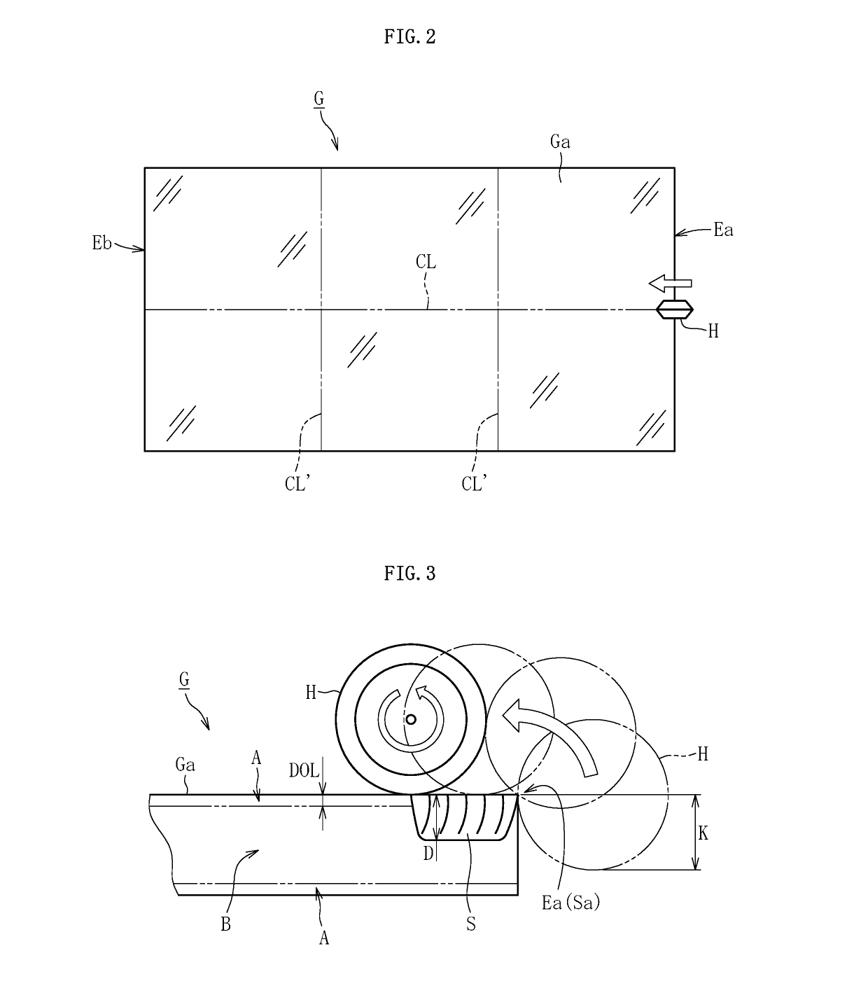

FIG. 2 is a plan view of the method of scribing a tempered glass sheet according to the first embodiment of the present invention. As illustrated in FIG. 2, a tempered glass sheet G for which the method is carried out has a rectangular shape. Further, as illustrated in FIG. 3, compressive stress layers A are formed on a front surface side and a back surface side of the tempered glass sheet G in its thickness direction, and a tensile stress layer B is formed between both the compressive stress layers A on the front surface side and the back surface side.

When the thickness of the tempered glass sheet G is represented by t [μm], the magnitude of compressive stress applied to each of both the compressive stress layers A is represented by CS [MPa], and the magnitude of tensile stress applied to the tensile stress layer B is represented by CT [MPa], those parameters satisfy the following relationships (1) to (3).

300≦t≦2,000 (1)

−0.00308×t+20.5343≦CT≦−0.00405×t+27.3791 (2)

600≦CS≦800 (3)

Note that, the magnitude CT of the tensile stress applied to the tensile stress layer B is represented by the following expression when the depth of each of both the compressive stress layers A is represented by DOL.

CT=CS×DOL/(t−DOL×2)

In this case, in this embodiment, the magnitude CS of the compressive stress of each of both the compressive stress layers A is 710 MPa, and the thickness DOL of each of both the compressive stress layers A is 20.8 μm. Further, the magnitude CT of the tensile stress of the tensile stress layer B is 21.4 MPa. Besides, the thickness t of the tempered glass sheet G is 700 μm.

Note that, the tempered glass sheet G (original glass sheet to be processed into the tempered glass sheet G) preferably has a composition containing, as a glass composition, in terms of mass %, 50% to 80% of SiO₂, 5% to 25% of Al₂O₃, 0% to 15% of B₂O₃, 1% to 20% of Na₂O, and 0% to 10% of K₂O. With this composition, a tempered glass sheet G excellent in both ion exchange performance and devitrification resistance can be obtained.

The scribing wheel H serving as the rotary scribing blade is moved on the tempered glass sheet G along a preset cutting line CL indicated by the two-dot chain line in FIG. 2, to thereby forma scribe line S for cutting the tempered glass sheet G. First, as illustrated in FIG. 2, the scribing wheel H is caused to climb onto an edge portion Ea, which is one of the edge portions of the tempered glass sheet G positioned on one end side of the preset cutting line CL, to thereby start forming the scribe line S. At this time, the scribing wheel H climbs onto the edge portion Ea in a direction orthogonal to the edge portion Ea.

Now, detailed description is given of how the scribing wheel H climbs onto the edge portion Ea. As illustrated in FIG. 3, the scribing wheel H is pressed against and hooked onto the edge portion Ea, and is moved upward along an arcuate locus about the edge portion Ea to reach a front surface Ga of the tempered glass sheet G. Thus, a starting end Sa of the scribe line S is formed on the tempered glass sheet G.

Note that, when the scribing wheel H and the edge portion Ea are brought into contact with each other, a depth K from the front surface Ga of the tempered glass sheet G to a lower end of the scribing wheel H is preferably defined based on the thickness t of the tempered glass sheet G. Specifically, the above-mentioned depth K is preferably from 5% to 50%, more preferably from 10% to 40%, still more preferably from 25% to 35% of the thickness t. For example, when the thickness t is 700 μm, the depth K is preferably from 0.04 mm to 0.35 mm, more preferably from 0.07 mm to 0.28 mm, still more preferably from 0.18 mm to 0.25 mm. When the scribing wheel H and the edge portion Ea are brought into contact with each other in this range of the depth K, the scribing wheel H is easily hooked onto the edge portion Ea, thereby being capable of smoothly forming the scribe line S.

Next, the scribing wheel H is moved along the preset cutting line CL while pressing the front surface Ga of the tempered glass sheet G against the scribing wheel H. In this case, when the scribing wheel H is moved along the preset cutting line CL, the pressing force of the scribing wheel H for pressing the front surface Ga of the tempered glass sheet G is set to 8.5 N. Further, the moving velocity of the scribing wheel H is set to 100 mm/s. Thus, a depth D of the scribe line S formed in the tempered glass sheet G is 3 times or more of the thickness DOL of the compressive stress layer A (=20.8 μm) and 60% or less of the thickness of the tempered glass sheet G (=700 μm).

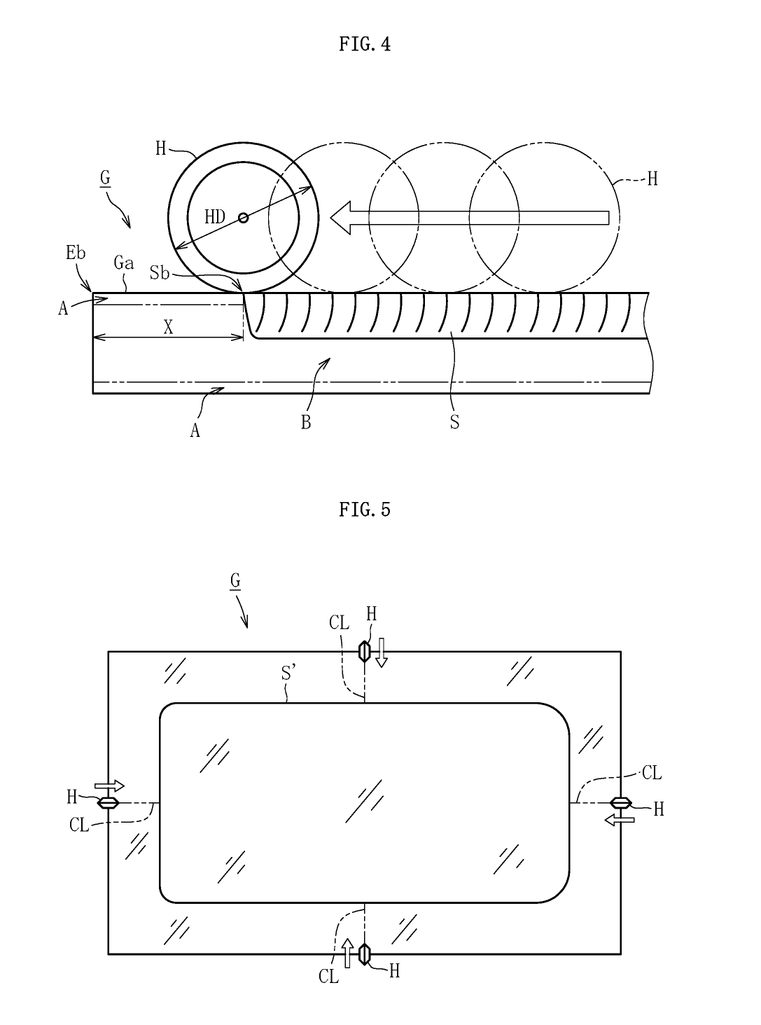

Further, as illustrated in FIG. 4, the scribing wheel H is moved to a position where the vicinity of an edge portion Eb of the tempered glass sheet G positioned on the other end side of the preset cutting line CL remains as an unscribed portion, and then the scribing wheel H is stopped or the pressing force of the scribing wheel H is released. At this time, the scribing wheel H is set so that a separation distance X between a terminal end Sb of the scribe line S and the edge portion Eb is 0.5 times or more and 3 times or less of a diameter HD of the scribing wheel H. In the above-mentioned manner, the formation of the scribe line S is finished.

Now, actions and effects of the above-mentioned method of scribing a tempered glass sheet according to the first embodiment of the present invention are described.

With the method of scribing a tempered glass sheet according to the first embodiment, the scribing wheel H is hooked onto the edge portion Ea when climbing onto the edge portion Ea, thereby preventing the idle rolling of the scribing wheel H to start the rolling suitably. Therefore, even in an initial stage of forming the scribe line S, the depth D of the scribe line S can be set to a depth suited to the operation of cutting the tempered glass sheet G by snapping (in this embodiment, 3 times or more of the thickness DOL of the compressive stress layer A and 60% or less of the thickness of the tempered glass sheet G).

Thus, when the tempered glass sheet G is cut by snapping along the scribe line S, there is no need to apply excessive bending moment to the tempered glass sheet G, thereby being capable of preventing such a situation that a crack generated from the scribe line S propagates in an unintended direction as in a situation where the crack deviates from a direction perpendicular to the front surface Ga of the tempered glass sheet G. As a result, it is possible to avoid degradation in quality of cut surfaces formed in the tempered glass sheet G.

Further, the scribing wheel H is caused to climb onto the edge portion Ea in the direction orthogonal to the edge portion Ea. Therefore, the scribing wheel H is hooked onto the edge portion Ea more easily, which leads to a further advantage in forming the scribe line S having a depth suited to the operation of cutting the tempered glass sheet G in the initial stage of forming the scribe line S.

Besides, the depth D of the scribe line S is set to 3 times or more of the thickness DOL of the compressive stress layer A and 60% or less of the thickness of the tempered glass sheet G. Therefore, the scribe line S is formed deeper in the thickness direction than in the related art (1 time or more and less than 3 times of the thickness of the compressive stress layer and from about 10% to about 20% of the thickness of the tempered glass sheet). Thus, when the tempered glass sheet G is cut by snapping along the scribe line S, the tempered glass sheet G can be snapped with small bending moment, and the propagation of the crack generated from the scribe line S in an unintended direction is prevented more appropriately.

Further, the permissible range of the depth D of the scribe line S to be formed is wider than in the related art. Therefore, when forming the scribe line S, the scribe line S can stably be formed to have a depth suited to the operation of cutting the tempered glass sheet G by snapping even though the pressing force of the scribing wheel H for pressing the tempered glass sheet G is fluctuated by, for example, small unevenness on the front surface Ga of the tempered glass sheet G. That is, the control of the pressing force can be facilitated significantly.

In addition, the separation distance X between the terminal end Sb of the scribe line S and the edge portion Eb is 0.5 times or more and 3 times or less of the diameter HD of the scribing wheel H, and hence the following effect can also be attained. When the separation distance X is excessively short, after the formation of the scribe line S is finished, the crack generated from the scribe line S may propagate due to the tensile stress layer B formed in the tempered glass sheet G to reach the edge portion Eb.

At this time, the tempered glass sheet G is in a state in which the scribe line S connecting the edge portion Ea positioned on one end side of the preset cutting line CL and the edge portion Eb positioned on the other end side of the preset cutting line CL is formed in the tempered glass sheet G. Therefore, the following trouble may occur in, for example, a production line of cutting the tempered glass sheet G by snapping after the formation of the scribe line S in the tempered glass sheet G at a step on an upstream side and the tempered glass sheet G is conveyed to a step on a downstream side by a belt conveyor or the like.

That is, the crack generated from the scribe line S may propagate in the thickness direction due to the tensile stress layer B formed in the tempered glass sheet G so that the tempered glass sheet is cut over the entire length of the scribe line S during the conveyance of the tempered glass sheet G. That is, the tempered glass sheet G is cut at an unintended timing. As a result, the opposing cut surfaces are brought into contact with each other due to vibrations or the like during the conveyance, thereby causing such a situation that the quality of the cut surfaces is degraded.

On the other hand, when the separation distance X is excessively long, and when the tempered glass sheet G is cut by snapping along the scribe line S, the crack generated from the scribe line S may propagate in an unintended direction deviating from the preset cutting line CL. When the separation distance X falls within the range of 0.5 times or more and 3 times or less of the diameter HD of the scribing wheel H, however, this trouble can be avoided suitably.

Note that, the scribing wheel H having the above-mentioned structure is used in the method of scribing a tempered glass sheet, and hence the following actions and effects can also be attained. That is, it is possible to avoid such a situation that, during the formation of the scribe line S, the scribing wheel H slips on the front surface Ga of the tempered glass sheet G, the impact force applied to the tempered glass sheet G becomes excessively large, and the front surface Ga of the tempered glass sheet G is liable to shatter. Therefore, it is possible to securely form the scribe line S having a sufficient depth D to cut the tempered glass sheet G.

In this case, scribe lines may further be formed after the tempered glass sheet G is split into a strip shape as described above, to thereby cut the tempered glass sheet G into three or more individual segments. For example, scribe lines may further be formed along a plurality of preset cutting lines CL′ illustrated in FIG. 2, to thereby cut the tempered glass sheet G. Note that, when the tempered glass sheet G is cut into individual segments after the tempered glass sheet G is cut into a strip shape, a split in an unintended direction and self-breakage due to the compressive stress and the tensile stress can be suppressed as compared to, for example, a case where the tempered glass sheet G is snapped after the scribe lines are formed in a plurality of directions. Further, the above-mentioned cutting method is an example, and the present invention is not limited thereto. For example, a plurality of scribe lines may be formed into a lattice shape in the tempered glass sheet G with the above-mentioned method, to thereby cut the tempered glass sheet G into individual segments. In the case of this structure, the tempered glass sheet G can be cut into individual segments within a short period of time, thereby being capable of enhancing the productivity of individual glass segments.

Note that, when cutting the tempered glass sheet G, the tempered glass sheet G may be cut through natural propagation of the crack of the scribe line S (hereinafter referred to as “natural cutting”), or may be cut through stress application for bending the tempered glass sheet G along the scribe line S (hereinafter referred to as “snap-cutting”). Note that, when the snap-cutting is desired, it is only necessary to apply bending stress to the tempered glass sheet G within preferably 180 seconds, more preferably 120 seconds, still more preferably 60 seconds after the formation of the scribe line S. When the tempered glass sheet G is left standing for 180 seconds or more after the formation of the scribe line S, the crack may naturally propagate to cause the natural cutting of the tempered glass sheet G unintendedly. Further, when the snap-cutting is desired, it is only necessary to apply bending stress to the tempered glass sheet G after an elapse of preferably 5 seconds or more, more preferably 10 seconds or more, still more preferably 15 seconds or more since the formation of the scribe line S in consideration of workability or the like.

Now, a method of scribing a tempered glass sheet according to a second embodiment of the present invention is described with reference to the accompanying drawings. Note that, in the description of the method of scribing a tempered glass sheet according to the second embodiment, the elements already described in the above-mentioned method of scribing a tempered glass sheet according to the first embodiment are represented by the same reference symbols in the drawings for illustrating the second embodiment, and redundant description of those elements is therefore omitted herein.

FIG. 5 is a plan view of the method of scribing a tempered glass sheet according to the second embodiment of the present invention. As illustrated in FIG. 5, the tempered glass sheet G for which the method is carried out has a rectangular shape. Further, to cut the tempered glass sheet G by snapping so as to cut out an effective surface portion having corner portions each curved into a round shape, a scribe line S′ having a closed-loop shape is already formed so as to surround the effective surface portion.

Besides, similarly to the tempered glass sheet G for which the above-mentioned method of scribing a tempered glass sheet according to the first embodiment is carried out, the magnitude of the compressive stress of each of both the compressive stress layers A of the tempered glass sheet G is 710 MPa, and the thickness DOL of each of both the compressive stress layers A of the tempered glass sheet G is 20.8 μm. Further, the magnitude of the tensile stress of the tensile stress layer B is 21.4 MPa. Moreover, other structure and preferred composition are also the same as those of the above-mentioned first embodiment.

The scribing wheels H serving as the rotary scribing blades are moved on the tempered glass sheet G along the preset cutting lines CL indicated by the two-dot chain lines in FIG. 5, to thereby form four scribe lines S for assisting a smooth operation of cutting out the effective surface portion. Note that, all of the four scribe lines S are formed in the same manner.

First, as illustrated in FIG. 5, each scribing wheel H is caused to climb onto one of the edge portions of the tempered glass sheet G positioned on one end side of the preset cutting line CL, to thereby start forming the scribe line S. Note that, in this embodiment, how the scribing wheel H is caused to climb onto the edge portion is similar to that of the above-mentioned first embodiment, and redundant description thereof is therefore omitted herein.

Next, the scribing wheel H is moved along the preset cutting line CL while pressing the front surface Ga of the tempered glass sheet G against the scribing wheel H. In this case, when the scribing wheel H is moved along the preset cutting line CL, the pressing force of the scribing wheel H for pressing the tempered glass sheet G is set to 10 N. Further, the moving velocity of the scribing wheel H is set to 15 mm/s. Thus, the depth D of the scribe line S formed in the tempered glass sheet G is 3 times or more of the thickness DOL of the compressive stress layer A (=20.8 μm) and 60% or less of the thickness of the tempered glass sheet G (=700 μm).

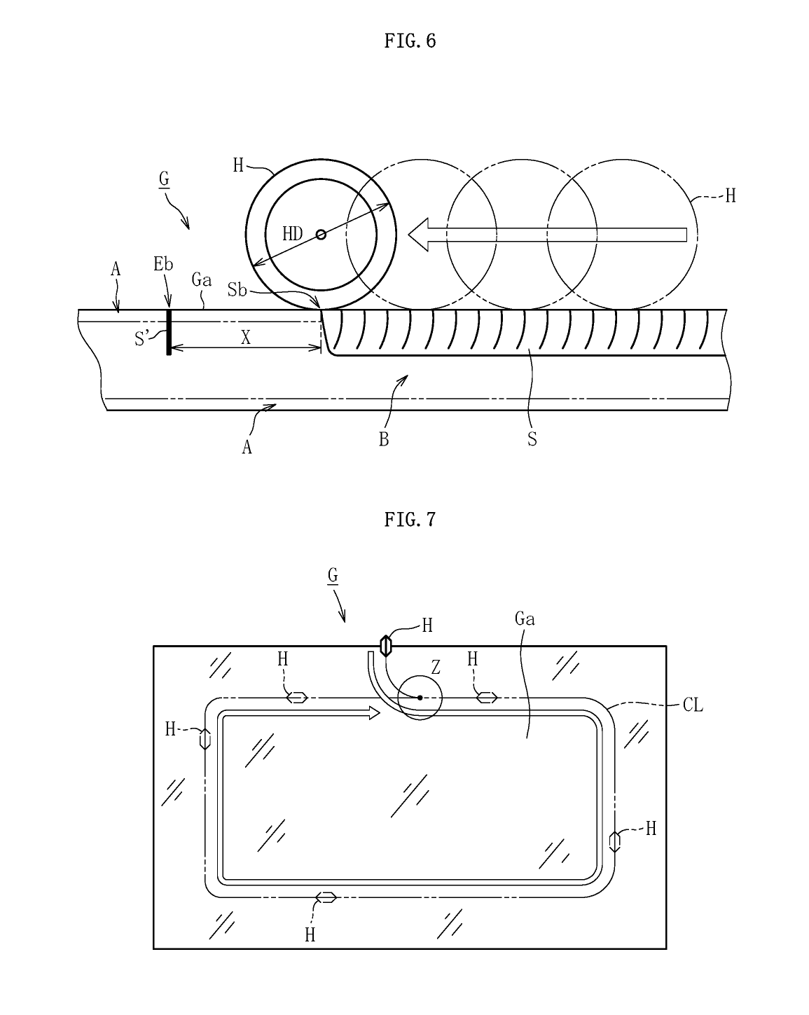

Further, as illustrated in FIG. 6, the scribing wheel H is moved to a position where the vicinity of the edge portion Eb positioned on the other end side of the preset cutting line CL remains as an unscribed portion, and then the scribing wheel H is stopped or the pressing force of the scribing wheel H is released. Note that, the edge portion Eb herein refers to, as illustrated in FIG. 6, a minute edge portion formed by the front surface Ga of the tempered glass sheet G and the scribe line S′ already formed in the tempered glass sheet G.

At this time, the scribing wheel H is stopped or the pressing force of the scribing wheel H is released so that the separation distance X between the terminal end Sb of the scribe line S and the edge portion Eb (scribe line S′) is 0.5 times or more and 3 times or less of the diameter HD of the scribing wheel H. In the above-mentioned manner, the formation of the scribe line S is finished.

Now, actions and effects of the above-mentioned method of scribing a tempered glass sheet according to the second embodiment of the present invention are described.

With the method of scribing a tempered glass sheet according to the second embodiment, the same actions and effects as those of the above-mentioned method of scribing a tempered glass sheet according to the first embodiment can be attained. Note that, in the second embodiment, when the separation distance X is excessively short, after the formation of the scribe line S is finished, the crack generated from the scribe line S may propagate due to the tensile stress layer B formed in the tempered glass sheet G to reach the effective surface portion. Further, when the crack has reached the effective surface portion, the strength of the cut tempered glass sheet G may be decreased. When the separation distance X is set to 0.5 times or more and 3 times or less of the diameter HD of the scribing wheel H, however, this situation can be avoided suitably.

Now, a method of scribing a tempered glass sheet according to a third embodiment of the present invention is described with reference to the accompanying drawings. Note that, in the description of the method of scribing a tempered glass sheet according to the third embodiment, the elements already described in the above-mentioned method of scribing a tempered glass sheet according to the first embodiment are represented by the same reference symbols in the drawings for illustrating the third embodiment, and redundant description of those elements is therefore omitted herein.

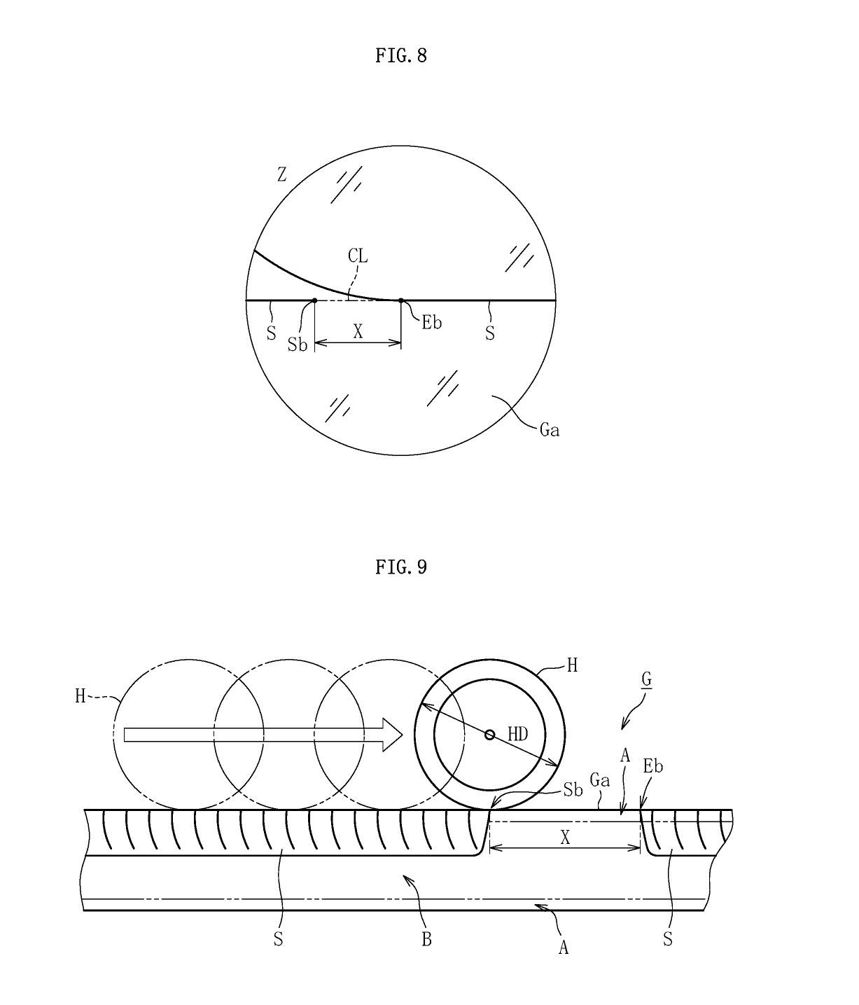

FIG. 7 is a plan view of the method of scribing a tempered glass sheet according to the third embodiment of the present invention. As illustrated in FIG. 7, the tempered glass sheet G for which the method is carried out has a rectangular shape. Besides, similarly to the tempered glass sheet G for which the above-mentioned method of scribing a tempered glass sheet according to the first embodiment is carried out, the magnitude of the compressive stress of each of both the compressive stress layers A of the tempered glass sheet G is 710 MPa, and the thickness DOL of each of both the compressive stress layers A of the tempered glass sheet G is 20.8 μm. Further, the magnitude of the tensile stress of the tensile stress layer B is 21.4 MPa. Moreover, other structure and preferred composition are also the same as those of the above-mentioned first embodiment.

As illustrated in FIG. 7, the scribing wheel H serving as the rotary scribing blade is moved on the tempered glass sheet G along a preset cutting line CL having a closed-loop shape indicated by the two-dot chain line, to thereby forma scribe line S for cutting out a substantially rectangular effective surface portion having curved corner portions from the tempered glass sheet G. Note that, in this embodiment, a part of the preset cutting line CL extending from the edge portion toward the preset cutting line CL having a closed-loop shape is connected to a linear part of the preset cutting line CL having a closed-loop shape.

First, as illustrated in FIG. 7, the scribing wheel H is caused to climb onto one of the edge portions of the tempered glass sheet G positioned on one end side of the preset cutting line CL, to thereby start forming the scribe line S. Then, the front surface Ga of the tempered glass sheet G is pressed against the scribing wheel H, and the moving direction of the scribing wheel H is changed gradually, to thereby smoothly join the scribe line S to the preset cutting line CL having a closed-loop shape while curving the scribe line S. At this time, the pressing force of the scribing wheel H for pressing the tempered glass sheet G is set to 9.4 N. Further, the moving velocity of the scribing wheel H is set to 15 mm/s. Note that, in this embodiment, how the scribing wheel H is caused to climb onto the edge portion is similar to that of the above-mentioned first embodiment, and redundant description thereof is therefore omitted herein.

Next, the scribing wheel H is moved along the preset cutting line CL having a closed-loop shape while pressing the front surface Ga of the tempered glass sheet G against the scribing wheel H. In this case, when the scribing wheel H is moved along the preset cutting line CL, the pressing force of the scribing wheel H for pressing the tempered glass sheet G is set to 8.5 N at the linear part of the preset cutting line CL, and to 9.4 N at the curved part of the preset cutting line CL. Further, the moving velocity of the scribing wheel H is set to 100 mm/s at the linear part of the preset cutting line CL, and to 20 mm/s at the curved part of the preset cutting line CL.

Thus, at the linear part of the preset cutting line CL having a closed-loop shape, the depth D of the scribe line S formed in the tempered glass sheet G is 3 times or more of the thickness DOL of the compressive stress layer A (=20.8 μm) and 60% or less of the thickness of the tempered glass sheet G (=700 μm). Further, at the curved part of the preset cutting line CL, the scribe line S is formed deeper than at the linear part of the preset cutting line CL. Therefore, when snapping the tempered glass sheet G, at the curved part of the preset cutting line CL, the tempered glass sheet G can be snapped with smaller bending moment than at the linear part of the preset cutting line CL.

Further, as illustrated in FIG. 8 (enlarged view of the portion Z of FIG. 7) and FIG. 9, the scribing wheel H is moved to a position where the vicinity of the edge portion Eb positioned on the other end side of the preset cutting line CL remains as an unscribed portion, and then the scribing wheel H is stopped or the pressing force of the scribing wheel H is released. Note that, the edge portion Eb herein refers to, as illustrated in FIG. 8 and FIG. 9, a minute edge portion formed by the front surface Ga of the tempered glass sheet G and the scribe line S already formed in the tempered glass sheet G.

At this time, the scribing wheel H is stopped or the pressing force of the scribing wheel H is released so that the separation distance X between the terminal end Sb of the scribe line S and the edge portion Eb (already-formed scribe line S) is 0.5 times or more and 3 times or less of the diameter HD of the scribing wheel H. In the above-mentioned manner, the formation of the scribe line S is finished.

Now, actions and effects of the above-mentioned method of scribing a tempered glass sheet according to the third embodiment of the present invention are described.

With the method of scribing a tempered glass sheet according to the third embodiment, the same actions and effects as those of the above-mentioned method of scribing a tempered glass sheet according to the first embodiment can be attained. Note that, in the third embodiment, when the separation distance X is excessively short, after the formation of the scribe line S is finished, the crack generated from the scribe line S may propagate due to the tensile stress layer B formed in the tempered glass sheet G to extend in a direction different from the already-formed scribe line S. When the separation distance X is set to 0.5 times or more and 3 times or less of the diameter HD of the scribing wheel H, however, this situation can be avoided suitably.

Note that, the method of scribing a tempered glass sheet according to the present invention is not limited to the method described in each of the above-mentioned embodiments. In each of the above-mentioned embodiments, the starting end of the scribe line is formed by causing the scribing wheel to climb onto the edge portion positioned on one end side of the preset cutting line in the direction orthogonal to the edge portion. For example, the starting end of the scribe line may be formed by causing the scribing wheel to climb onto the edge portion in a direction forming an inclination angle with respect to the edge portion. In this case, the value of the inclination angle is preferably 45° or less with respect to the direction orthogonal to the edge portion.

Further, in each of the above-mentioned embodiments, the formation of the scribe line is finished by stopping the movement of the scribing wheel or releasing the pressing force of the scribing wheel H. However, the present invention is not limited thereto. For example, the formation of the scribe line may be finished by upwardly moving the scribing wheel, which is moved to the position where the vicinity of the edge portion positioned on the other end side of the preset cutting line remains as an unscribed portion, so that the scribing wheel is spaced away from (lifted off) the front surface of the tempered glass sheet.

Besides, in each of the above-mentioned embodiments, the scribe line is formed in the rectangular tempered glass sheet. The method of scribing a tempered glass sheet according to the present invention is applicable to, for example, a tempered glass sheet having an arbitrary shape such as a circular or elliptical shape.

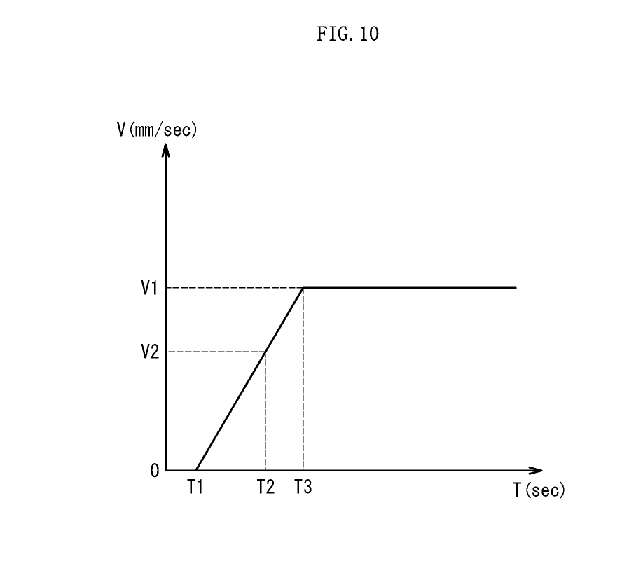

Note that, in each of the above-mentioned embodiments, when forming the scribe line S, it is preferred that the scribing wheel H be caused to climb onto the edge portion Ea while being brought into contact with the edge portion Ea under an accelerated state. Specifically, as shown in FIG. 10, when the velocity of the scribing wheel H is gradually increased during a period from a time T1 to a time T3, it is appropriate to control the operation of the scribing wheel H or adjust the position of the tempered glass sheet G so that the tempered glass sheet G climbs onto the edge portion Ea at an arbitrary time T2 between the time T1 and the time T3. That is, it is preferred to continuously accelerate the scribing wheel H before and after climbing onto the edge portion Ea, and to continue the acceleration while moving the scribing wheel H on the front surface Ga of the tempered glass sheet G until the velocity reaches a predetermined target velocity V1. With this structure, the scribing wheel H can easily be caused to climb onto the edge portion Ea, thereby being capable of forming the scribe line S stably. Note that, the velocity of the scribing wheel H may be increased linearly, exponentially, or logarithmically during the acceleration. Further, when the velocity of the scribing wheel H at the time of contact with the edge portion Ea is defined as a contact velocity V2, it is preferred that the contact velocity V2 be adjusted within a range of from 1 mm/sec to 40 mm/sec. When the contact velocity V2 is more than 40 mm/sec, the tempered glass sheet G may be damaged at the time of contact between the scribing wheel H and the edge portion Ea.

### EXAMPLES

As examples of the present invention, using the same method as the above-mentioned method of scribing a tempered glass sheet according to the first embodiment, a scribe line was formed by applying a pressing force to a tempered glass sheet from a scribing wheel moving on a front surface of the tempered glass sheet. After that, an attempt was made to cut, by snapping, the tempered glass sheet having the scribe line formed therein. Then, the formation of the scribe line and the attempt to cut the tempered glass sheet were carried out while changing the pressing force, to thereby investigate the range of the pressing force capable of cutting the tempered glass sheet.

Now, conditions for carrying out the examples of the present invention are described.

As the tempered glass sheet, twelve types of tempered glass sheets No. 1 to No. 12 as listed in [Table 1] and [Table 2] were used. A method of manufacturing those tempered glass sheets is described. First, glass sheets having dimensions of 370=long and 470 mm wide and also having the thicknesses listed in [Table 1] and [Table 2] (original glass sheets to be processed into the tempered glass sheets No. 1 to No. 12) were prepared. Note that, compositions of the glass sheets are common and each contain, in terms of mass %, 66% of SiO₂, 14.2% of Al₂O₃, 13.4% of Na₂O, 0.6% of K₂O, 0.1% of Li₂O, 2.3% of B₂O₃, 3.0% of MgO, and 0.4% of SnO₂. Then, the glass sheets were chemically tempered through ion exchange so as to have the magnitudes of compressive stress and the thicknesses of compressive stress layers as listed in [Table 1] and [Table 2], to thereby manufacture tempered glass sheets.

Next, using a scribing wheel having the pitch, depth, and width of cutout portions as listed in [Table 1] and [Table 2], a scribe line was formed while applying a pressing force to the front surface of each tempered glass sheet. After that, an attempt was made to cut, by snapping, each tempered glass having the scribe line formed therein. Note that, the scribe line was formed while changing the pressing force. Specifically, fifteen tempered glass sheets were prepared for each of the types of tempered glass sheets No. 1 to No. 12, and a scribe line was formed in each of the fifteen tempered glass sheets with the same pressing force. After that, an attempt was made to cut each of the fifteen tempered glass sheets. Then, the pressing force was changed, and a scribe line was formed in each of the fifteen tempered glass sheets with the same pressing force (changed pressing force) again. After that, an attempt was made to cut each of the fifteen tempered glass sheets. In this manner, the formation of the scribe line, the attempt to cut the tempered glass sheet, and the change of the pressing force were repeated.

Finally, the range of the pressing force capable of cutting the tempered glass sheet was calculated. Specifically, the range of the pressing force capable of cutting nine or more tempered glass sheets was calculated as a result of the attempt to cut each of the fifteen tempered glass sheets having the scribe lines formed therein. Now, description is given by taking as an example the tempered glass sheets No. 1 as listed in [Table 1]. In [Table 1], the case of the tempered glass sheets No. 1 means that nine or more tempered glass sheets out of the fifteen tempered glass sheets were able to be cut when the pressing force for forming the scribe line fell within a range of from 10 N to 13 N. That is, the range of the pressing force capable of cutting the tempered glass sheet is from 10 N to 13 N.

Results of investigation of the ranges of the pressing force capable of cutting the tempered glass sheets No. 1 to No. 12 are shown in [Table 1] and [Table 2].

TABLE 1

| | No. | | | | | |
|---|---|---|---|---|---|---|
| | 1 | 2 | 3 | 4 | 5 | 6 |
| Thickness [μm] | 400 | 400 | 400 | 400 | 1,100 | 1,100 |
| Magnitude of | 665 | 665 | 665 | 665 | 736 | 736 |
| compressive stress | | | | | | |
| [MPa] | | | | | | |
| Thickness of | 12 | 12 | 12 | 12 | 32 | 32 |
| compressive stress | | | | | | |
| layer [μm] | | | | | | |
| Pitch of cutout | 160 | 80 | 40 | 20 | 160 | 80 |
| portions [μm] | | | | | | |
| Depth of cutout | 2 | 2 | 2 | 2 | 2 | 2 |
| portion [μm] | | | | | | |
| Width of cutout | 5 | 5 | 5 | 5 | 5 | 5 |
| portion [μm] | | | | | | |
| Pressing force [N] | 10-13 | 9-15 | 9-15 | 10-13 | 16-18 | 22-26 |

TABLE 2

| | No. | | | | | |
|---|---|---|---|---|---|---|
| | 7 | 8 | 9 | 10 | 11 | 12 |
| Thickness [μm] | 1,100 | 1,100 | 400 | 400 | 1,100 | 1,100 |
| Magnitude of | 736 | 736 | 665 | 665 | 736 | 736 |
| compressive | | | | | | |
| stress [MPa] | | | | | | |
| Thickness of | 32 | 32 | 12 | 12 | 32 | 32 |
| compressive | | | | | | |
| stress layer | | | | | | |
| [μm] | | | | | | |
| Pitch of cutout | 40 | 20 | 1,600 | 17 | 1,600 | 17 |
| portions [μm] | | | | | | |
| Depth of cutout | 2 | 2 | 2 | 3 | 2 | 3 |
| portion [μm] | | | | | | |
| Width of cutout | 5 | 5 | 5 | 10 | 5 | 10 |
| portion [μm] | | | | | | |
| Pressing force [N] | 22-26 | 19-21 | 10-11 | 12-13 | 17 | 20-21 |

Based on the results of [Table 1] and [Table 2], it is found that the range of the pressing force capable of cutting the tempered glass sheet becomes wider in the cases of No. 1 to No. 8 than in the cases of No. 9 to No. 12. That is, the tempered glass sheet can be cut stably with less influence of fluctuation in conditions of the formation of the scribe line. It is supposed that the above-mentioned results were obtained because the formation pitch of the cutout portions of the scribing wheel ranged from 20 μm to 160 μm, the depth of the cutout portion ranged from 1.0 μm to 2.5 μm, and the width of the cutout portion ranged from 3 μm to 8 μm in the cases of No. 1 to No. 8.

### REFERENCE SIGNS LIST

G tempered glass sheet
Ga front surface of tempered glass sheet
t thickness of tempered glass sheet
CL preset cutting line
H scribing wheel
HD diameter of scribing wheel
C cutout portion
P pitch of cutout portion
DH depth of cutout portion
W width of cutout portion
K initial position of scribing wheel
S scribe line
Sa starting end of scribe line
Sb terminal end of scribe line
D depth of scribe line
Ea edge portion positioned on one end side of preset cutting line
Eb edge portion positioned on other end side of preset cutting
line
A compressive stress layer
DOL thickness of compressive stress layer
X separation distance

1. A method of scribing a tempered glass sheet, which involves forming a scribe line for cutting the tempered glass sheet with a rotary scribing blade moving along a preset cutting line while pressing a front surface of the tempered glass sheet,
the method comprising:
starting the forming of the scribe line by causing the rotary scribing blade to climb onto one of edge portions of the tempered glass sheet, which is positioned on one end side of the preset cutting line; and
finishing the forming of the scribe line by moving the rotary scribing blade to a position where a vicinity of another of the edge portions of the tempered glass sheet, which is positioned on another end side of the preset cutting line, remains as an unscribed portion.

2. The method of scribing a tempered glass sheet according to claim 1, wherein a depth of the scribe line is set to 3 times or more of a thickness of a compressive stress layer formed in a surface layer region of the tempered glass sheet, and to 60% or less of a thickness of the tempered glass sheet.

3. The method of scribing a tempered glass sheet according to claim 1, wherein the starting of the forming of the scribe line comprises causing the rotary scribing blade to climb onto the one of the edge portions, which is positioned on the one end side of the preset cutting line, in a direction orthogonal to the one of the edge portions.

4. The method of scribing a tempered glass sheet according to claim 1, wherein a separation distance between the another of the edge portions, which is positioned on the another end side of the preset cutting line, and a terminal end of the scribe line is set to 0.5 times or more and 3 times or less of a diameter of the rotary scribing blade.

5. The method of scribing a tempered glass sheet according to claim 1,
wherein a cutting edge of the rotary scribing blade has a plurality of cutout portions formed therein along a circumferential direction of the rotary scribing blade,
wherein a formation pitch of the plurality of cutout portions ranges from 20 μm to 160 μm,
wherein a depth of each of the plurality of cutout portions ranges from 1.0 μm to 2.5 μm, and
wherein a width of the each of the plurality of cutout portions along the circumferential direction of the rotary scribing blade ranges from 3 μm to 8 μm.

6. The method of scribing a tempered glass sheet according to claim 1,
wherein the tempered glass sheet comprises:
compressive stress layers formed in surface layer regions on a front surface side and a back surface side of the tempered glass sheet, respectively; and
a tensile stress layer formed between both the compressive stress layers, and
wherein the following relationships are satisfied:
300≦t≦2,000;
−0.00308×t+20.5343≦CT≦−0.00405×t+27.3791; and
600≦CS≦700,
where a thickness of the tempered glass sheet is represented by t [μm], a magnitude of compressive stress applied to each of the compressive stress layers is represented by CS [MPa], and a magnitude of tensile stress applied to the tensile stress layer is represented by CT [MPa].

7. The method of scribing a tempered glass sheet according to claim 1, wherein the starting of the forming of the scribe line comprises bringing the rotary scribing blade into contact with the one of the edge portions, which is positioned on the one end side of the preset cutting line, under an accelerated state.

8. A method of cutting a tempered glass sheet, comprising:
cutting the tempered glass sheet into a strip shape by using the method of scribing a tempered glass sheet of claim 1; and
further cutting the tempered glass sheet having the strip shape into individual segments.

9. A method of cutting a tempered glass sheet, comprising:
forming a scribe line in the tempered glass sheet by using the method of scribing a tempered glass sheet of claim 1; and
cutting the tempered glass sheet by snapping through application of bending stress to the tempered glass sheet.

10. The method of cutting a tempered glass sheet according to claim 9, wherein the cutting of the tempered glass sheet by snapping comprises applying the bending stress to the tempered glass sheet within 180 seconds after the forming of the scribe line in the tempered glass sheet.
